(19) United States
(12) Patent Application Publication
(10) Pub. No.: US 2026/0339291 A1
(43) Pub. Date: Oct. 29, 2026

(54) METHOD AND APPARATUS WITH EQUIPMENT MANAGEMENT

(71) Applicant: Samsung Electronics Co., Ltd., Suwon-si (KR)

(72) Inventors: Keunseo KIM, Suwon-si (KR); Sangdo PARK, Suwon-si (KR); Kaeweon YOU, Suwon-si (KR); Saena CHOI, Suwon-si (KR); Junwoo SONG, Suwon-si (KR)

(73) Assignee: Samsung Electronics Co., Ltd., Suwon-si (KR)

(21) Appl. No.: 19/569,260

(22) Filed: Mar. 17, 2026

(30) Foreign Application Priority Data
Apr. 24, 2025 (KR) 10-2025-0054041
Jun. 18, 2025 (KR) 10-2025-0080564

(51) Int. Cl. G05B 19/4099

(52) U.S. Cl. CPC G05B 19/4099; G05B 2219/45031

(57) ABSTRACT

A processor-implemented method including generating a first trend image of first sensor data responsive to detecting an anomaly in a first piece of equipment, the first sensor data observing the first piece of equipment, generating one or more second trend images of second sensor data obtained from normally operating one or more second pieces of equipment, a second equipment type of the one or more second pieces of equipment corresponding to a first equipment type of the first piece of equipment, and determining a validity of the anomaly detected in the first piece of equipment by using a per trend similarity determined per trend pair formed between the first trend image and the one or more second trend images.

### CROSS-REFERENCE TO RELATED APPLICATIONS

This application claims the benefit of Korean Patent Application No. 10-2025-0080564, filed on Jun. 18, 2025 and Korean Provisional Patent Application No. 10-2025-0054041, filed on Apr. 24, 2025 in the Korean Intellectual Property Office, the disclosures of which are incorporated herein by reference in its entirety.

### BACKGROUND

### 1. Field of the Invention

Example embodiments relate to a method and apparatus with equipment management.

### 2. Description of the Related Art

Stable equipment operation is an important factor to improve manufacturing efficiency and ensure product quality across various manufacturing processes, including a semiconductor production. When equipment anomalies are not detected at an early stage, they may lead to process interruptions, increased defect rates, and even major equipment failures, which cause a significant economic loss and waste of time.

Meanwhile, to detect equipment anomalies, a predefined management standard is required for each sensor in every piece of equipment. However, as manufacturing processes become complex and the number and variety of sensors to be managed continue to increase, there is a desire for technology that changes depending on an operation environment of various types of equipment and manages pieces of equipment while applied to various kinds of processes and sensors and detecting anomalies in an adaptive manner.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a first trend image of first sensor data responsive to detecting an anomaly in a first piece of equipment, the first sensor data observing the first piece of equipment, generating one or more second trend images of second sensor data obtained from normally operating one or more second pieces of equipment, a second equipment type of the one or more second pieces of equipment corresponding to a first equipment type of the first piece of equipment, and determining a validity of the anomaly detected in the first piece of equipment by using a per trend similarity determined per trend pair formed between the first trend image and the one or more second trend images.

The first trend image may correspond to a first image, the first image being generated based on a first equipment management event occurring during a first reference time of the first piece of equipment and the first sensor data and the one or more second trend images may correspond to a second image, the second image being generated based on a second equipment management event occurring during a second reference time of a second piece of equipment and the second sensor data.

The first equipment management event may include one or more of a maintenance history, a repair history, and a part replacement history of each piece of equipment.

The first reference time may be set variably for first processes of the first piece of equipment measured by the first sensor.

The first trend image may include a first change of the first sensor data based on the first equipment management event of the first piece of equipment and the one or more second trend images may include a second change of the second sensor data based on the second equipment management event of the second piece of equipment.

The per trend similarity may be determined based on an encoder and an artificial intelligence (AI) model including a classifier selected in consideration of the encoder.

A first encoder corresponding to the first trend image and a second encoder corresponding to the one or more second trend images may share a weight.

The encoder may determine a first feature vector corresponding to the first trend image and a second feature vector corresponding to the one or more second trend images and the classifier may determine a vector similarity between the first feature vector and the second feature vector.

The generating of one or more second trend images may include generating the one or more second trend images from respective ones of the one or more second pieces of equipment selected in consideration of one or more of a first similarity to the first piece of equipment, an accident history for each second piece of equipment, and a rate of anomaly validity determination for each second piece of equipment.

The determining of the validity may include determining the validity of the anomaly by comparing, in consideration of the trend similarity determined per the trend pair, a number of times the anomaly of the first piece of equipment is identified as a false detection with a threshold count.

The method may include, responsive to the anomaly of the first piece of equipment being identified as a false detection, requesting a release of an interlock state of the first piece of equipment.

The threshold count may be a value determined based on one or more of a first process in which the first piece of equipment is used, an accident history of the first piece of equipment, and a number of the one or more second pieces of equipment.

In a general aspect, here is provided a processor-implemented method including identifying a first trend image of first sensor data obtained from a first equipment responsive to an anomaly being detected in the first equipment and the first equipment being in an interlock state, identifying a second trend image of second sensor data obtained from normally operating second equipment, the second equipment corresponding to the first equipment, and determining whether to release the interlock state of the first equipment based on a number of one or more second trend images identified to be similar to the first trend image from among the one or more second trend images.

The first trend image may correspond to a first image generated based on a first equipment management event occurring during a first reference time of the first equipment and the first sensor data and the one or more second trend images may correspond to second images generated based on a second equipment management event occurring during a second reference time of the second equipment and the second sensor data.

The first equipment management event and the second equipment management event may each include one or more of a maintenance history, a repair history, and a part replacement history of the first equipment and the second equipment.

The first reference time may be set variably for first processes of the first equipment measured by the first sensor.

The first trend image may include a first change of the first sensor data based on the first equipment management event of the first equipment and the one or more second trend images may include a second change of the second sensor data based on the second equipment management event of the second equipment.

The one or more second trend images may be identified to be similar to the first trend image based on an encoder and an artificial intelligence (AI) model including a classifier selected in consideration of the encoder.

A first encoder corresponding to the first trend image and a second encoder corresponding to the one or more second trend images may share a weight.

In a general aspect, here is provided an electronic apparatus including one or more processors including processing circuitry and a memory including one or more storage media storing instructions that, when executed individually or collectively by the one or more processors, cause the electronic apparatus to generate a first trend image of first sensor data obtained from first equipment in which an anomaly is detected, and one or more second trend images of second sensor data obtained from one or more normally operating second equipment, the first equipment corresponding to the second equipment, determine a similarity per trend pair between the first trend image and the one or more second trend images, and determine a validity of the anomaly detected in the first equipment in consideration of the similarity.

### BRIEF DESCRIPTION OF THE FIGURES

FIG. 1 illustrates an example system including equipment and an electronic apparatus for equipment management according to one or more embodiments.

FIG. 2 illustrates an example method with equipment management according to one or more embodiments.

FIG. 3 illustrates an example sensor data processing process for managing equipment according to one or more embodiments.

FIG. 4 illustrates an example trend image of sensor data of a first piece of equipment and a second piece of equipment according to one or more embodiments.

FIG. 5 illustrates example sensor data of first piece of equipment in which an anomaly is detected according to one or more embodiments.

FIG. 6 illustrates an example process with determining a similarity based on an artificial intelligence model according to one or more embodiments.

FIG. 7 illustrates an example process with determining a validity of an anomaly detected in equipment, in consideration of similarity for each trend pair according to one or more embodiments.

FIG. 8 illustrates an example trend pair including a first trend image and a second trend image according to one or more embodiments.

FIG. 9 illustrates an example process with determining a validity of an anomaly detected in a first piece of equipment according to one or more embodiments.

FIG. 10 illustrates an example process with determining a validity of an anomaly according to one or more embodiments.

FIG. 11 illustrates an example method with equipment management according to one or more embodiments.

FIG. 12 illustrates an example method with equipment management according to one or more embodiments.

FIG. 13 illustrates an example electronic apparatus according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

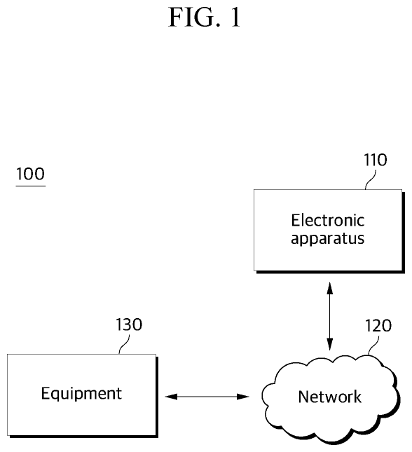

FIG. 1 illustrates an example system including equipment and an electronic apparatus for equipment management according to one or more embodiments.

Referring to FIG. 1, in a non-limiting example, a system 100 may include an electronic apparatus 110 or equipment 130. The equipment 130 is illustrated as a single apparatus in FIG. 1 for clearer description, but the equipment 130 may be plural unlike what is described in FIG. 1, and the number of pieces of equipment may vary depending on a type and a range of equipment managed by the electronic apparatus 110.

In an example, the electronic apparatus 110 and the equipment 130 may perform wireless or wire communication through a network 120. The electronic apparatus 110 may obtain sensor data from the equipment 130 during a predetermined period (a reference time) and manage a state of the equipment 130 by using a trend of the sensor data. For example, the electronic apparatus 110 may identify whether an anomaly exists based on the trend of the sensor data of the equipment 130 and manage whether to release an interlock state of the equipment 130 based on whether an anomaly exists.

Examples in which the electronic apparatus 110 manages a state of the equipment 130 will be described in greater detail below.

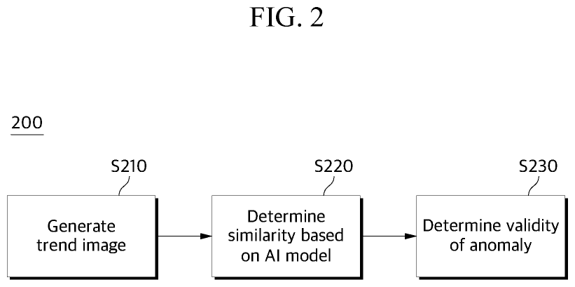

FIG. 2 illustrates an example method with equipment management according to one or more embodiments.

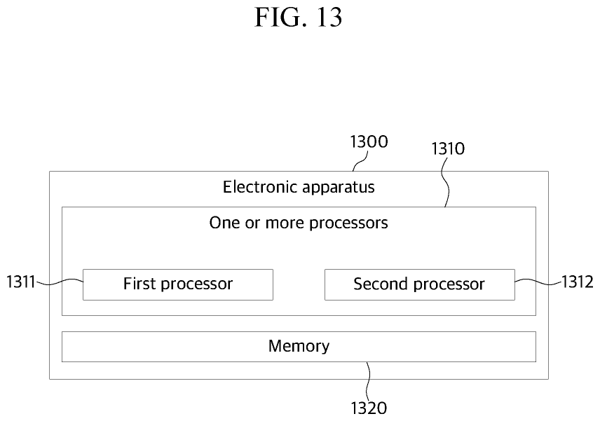

Referring to FIG. 2, in a non-limiting example, a method 200 with equipment management of may be performed by an electronic apparatus (e.g., electronic device 1300 of FIG. 13).

In an example, in step S210, an electronic apparatus (e.g., electronic device 1300) may generate a trend image by processing sensor data obtained from each piece of equipment.

First, sensor data may be obtained from a first piece of equipment (i.e., first equipment) in which an anomaly is detected in addition to sensor data from one or more pieces of second equipment (i.e., second equipment) where the second equipment is of the same type of equipment as the first piece of equipment. That is, sensor data may be collected or obtained from other equipment corresponding to the first piece of equipment.

At this point, the sensor data obtained from the first piece of equipment may be data collected from a main sensor from among one or more sensors included in the first piece of equipment. As an example, the main sensor may be a sensor that is suspected of causing an anomaly in a piece of equipment and may need attention. The main sensor may be determined for each piece of equipment based on a major accident history of each sensor and may be a sensor causing an anomaly in the first piece of equipment. In addition, the main sensor may refer to all sensors of the same type within a piece of equipment that possibly has an anomaly. In addition, there is no limit to the number of sensors in equipment that may be considered a main sensor. That is, the number of the main sensors may be more than one for any piece of equipment. In addition, the sensor data obtained from a second piece of equipment may be sensor data of a sensor (corresponding to the main sensor of the first piece of equipment) that operates normally in the second piece of equipment.

At this point, each of the sensor data of the first piece of equipment and the sensor data of the second piece of equipment may be data collected during a reference time, and the reference time during which the data is collected may be determined based on at least one of a type of the first piece of equipment and the second piece of equipment, a process and a sensor involving the first piece of equipment and the second piece of equipment.

In addition, the second piece of equipment may refer to one or more second pieces of equipment selected from among multiple second pieces of equipment. For example, one or more pieces of the second piece of equipment may be selected from among multiple pieces of the second piece of equipment based on an accident history for each second piece of equipment, equipment similarity with the first piece of equipment, and a rate of anomaly validity determination for each second piece of equipment (for example, an anomaly decision rate for another piece of equipment when the second piece of equipment was previously used to determine validity of an anomaly that occurred in another piece of equipment).

At this point, the electronic apparatus may generate a trend image by processing sensor data obtained from each piece of equipment. A trend of the sensor data obtained from each piece of equipment may be identified based on the trend image. The electronic apparatus may generate a first trend image by identifying and visualizing a trend of sensor data of the first piece of equipment and generate a second trend image by identifying and visualizing a trend of sensor data of the second piece of equipment during a reference time. One or more of the second trend images may be provided depending on the number of the second pieces of equipment, and may form a trend pair, corresponding to the first trend image. For example, when there is the first trend image and three second trend images, the first trend image and a first second trend image may form a first trend pair, the first trend image and a second trend image may form a second trend pair, and the first trend image and a third second trend image may form a third trend pair. Meanwhile, a process of visualizing a trend of sensor data may include a process of rendering the sensor data as a two-dimensional image, that is, within a space defined by an x-axis and a y-axis. The x-axis and the y-axis may be a reference to identify a trend of sensor data, and for example, the x-axis may be time, and the y-axis may be a value of the sensor data. However, the trend image based on the sensor data may be rendered as an image using other dimensions (i.e., other than two dimensions), in a manner in which a trend may be identified.

In addition, in an example, the process of visualizing the trend of sensor data may include a process of generating a trend image, including an equipment management event that corresponds to a regular maintenance history and an equipment repair history. The equipment management event may be rendered as a vertical line on a trend image, and through such a process, a change point of sensor data of each piece of equipment may be included in each trend image.

Examples of processing the sensor data will be described in greater detail below.

In an example, in step S220, an electronic apparatus (e.g., electronic device 1300) may determine a similarity for each trend pair, a trend image pair of sensor data, to detect an anomaly of equipment. When determining similarity for each trend pair, an artificial intelligence (AI) model may be used. In other words, a similarity between the first trend image and the second trend image included in a trend pair may be determined based on the AI model. Here, the AI model that is used may be a trained model by using a trend pair composed of a trend image, and for example, may be a model implemented in various forms such as a neural network (NN), a convolutional NN (CNN), a long short-term memory (LSTM), a transformer-based model (for example, vision transformer (ViT) or MambaVision). In addition, the AI model may include various models, which may be included in the present disclosure.

In an example, the AI-based model may include an encoder configured to extract a feature vector for each trend image and a classifier configured to analyze similarity by using the extracted feature vector.

Hereinafter, a process of determining similarity based on the AI model will be described in detail in another diagram.

In an example, in step S230, an electronic apparatus (e.g., electronic device 1300 of FIG. 13) may determine a validity of an anomaly of a piece of equipment, in which an anomaly has been detected. That is, the first piece of equipment. The first piece of equipment may be in an interlock state as equipment in which an anomaly is detected (i.e., an anomalous condition), while the second piece of equipment may correspond to the first piece of equipment while operating normally (i.e., a normal condition). Based on the similarity determined for each trend pair between the first trend image and the second trend image of one or more second pieces of equipment, the electronic apparatus may determine validity of an anomaly detected in the first piece of equipment. At this point, in consideration of similarity determined for each trend pair, the electronic apparatus may determine whether to release an interlock of the first piece of equipment, based on the number of times an anomaly of the first piece of equipment is determined to be a true anomaly and a threshold count.

Hereinafter, a process of determining validity of an anomaly of the first piece of equipment will be described in greater detail below.

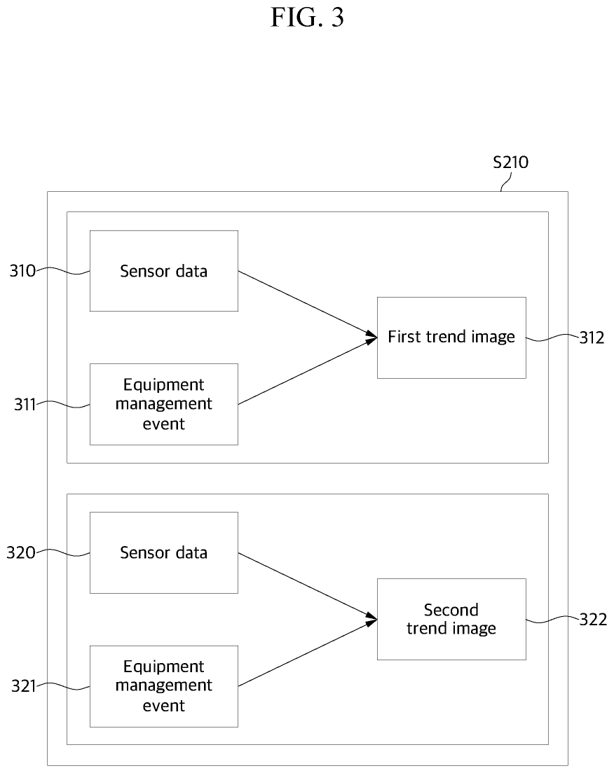

FIG. 3 illustrates an example sensor data processing process for managing equipment according to one or more embodiments. The sensor data processing procedure of FIG. 3 may be performed by an electronic apparatus (e.g., electronic device 1300 of FIG. 13).

Referring to FIG. 3, in a non-limiting example, an electronic apparatus (e.g., electronic device 1300 of FIG. 13) may generate a first trend image 312 by using sensor data 310 of a first piece of equipment and an equipment management event 311 of the first piece of equipment. As described above, the sensor data 310 of the first piece of equipment may be data obtained during a reference time from a major sensor, that is, one or more main sensors that cause an anomaly of the first piece of equipment among sensors included in the first piece of equipment. In addition, the equipment management event 311 may include at least one of an accident history of the first piece of equipment that occurred during a reference time, during which data is collected (for example, line stoppage, a chemical hazard situation, an event causing a product defect, a software error, and a quality-related issue), maintenance history (for example, a result of a regular safety inspection, an equipment cleaning and tuning history), a part replacement history (for example, replacement date and time, a name of replaced part, a reason for replacement), and other management histories (for example, an equipment relocation history, an equipment operating hour, a utilization rate, a software update history). The equipment management event 311 may occur more than once during a reference time in which the sensor data 310 of the first piece of equipment is obtained. In this case, when compared to before the equipment management event occurs, a change (for example, a change in dispersion) may occur in the sensor data 310 of the first piece of equipment. For example, before the equipment management event occurs, the sensor data 310 of the first piece of equipment may exhibit a trend starting near a value n and increasing to a value k while operating at regular intervals. After the equipment management event occurs, the sensor data 310 of the first piece of equipment may exhibit an increasing trend while operating at regular intervals, but mostly exhibit a trend starting near a value m and increasing to a value y. The electronic apparatus may generate the first trend image 312 including a change of the sensor data 310 and a reason for the change.

In an example, the electronic apparatus may generate a second trend image 322 by using sensor data 320 of the second piece of equipment and an equipment management event 321 of the second piece of equipment. The second trend image may be generated in the same manner as the first trend image. However, the second piece of equipment may refer to one or more pieces selected from among multiple second pieces of equipment, and the second trend image may be generated for each of the one or more second pieces of equipment. Accordingly, the second trend image may also refer to one or more images depending on the number of the second pieces of equipment.

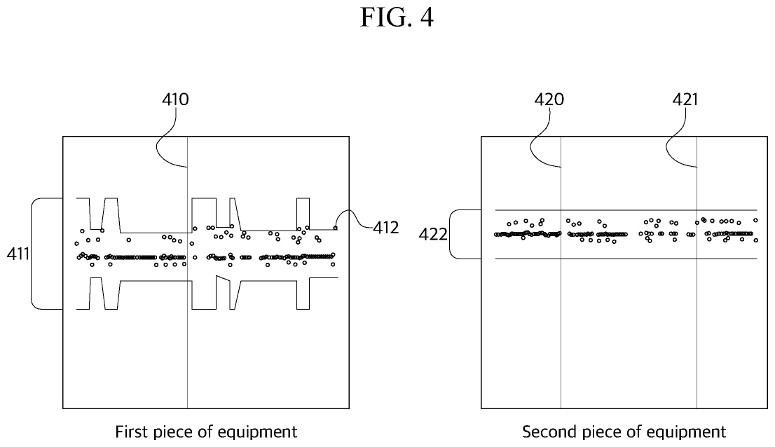

Meanwhile, a period during which the sensor data 310 of the first piece of equipment is collected and a reference time during which the sensor data 320 of the second piece of equipment is obtained may be identical, but a frequency of occurrence of the equipment management event 311 of the first piece of equipment and the equipment management event 321 of the second piece of equipment may be identical or different even during the same reference time. Although the frequency of occurrence of an equipment management event is different for each piece of equipment, the equipment management event may be reflected to a trend image for each piece of equipment. In an example, the frequency of occurrence of the equipment management event may be different for each piece of equipment as described in greater detail below with reference to FIG. 4.

FIG. 4 illustrates an example trend image of sensor data of a first piece of equipment and a second piece of equipment according to one or more embodiments.

Referring to FIG. 4, in a non-limiting example, a trend image for sensor data of the first piece of equipment (hereinafter, a first trend image) and a trend image for sensor data of the second piece of equipment (hereinafter, a second trend image) are illustrated and may each be rendered as a two-dimensional image with an x-axis and a y-axis. The x-axis and the y-axis may be a reference to identify a trend of sensor data, and for example, the x-axis may be time, and the y-axis may be a value of the sensor data. A trend image of the sensor data may also be rendered as images using various other dimensional arrangements to identify a trend in the sensor data.

First, the first piece of equipment may be in an interlock state in which an anomaly is detected. The anomaly for first piece of equipment may be detected due to data 412 being outside a normal range among sensor data (i.e., an anomaly), and a validity of the detected anomaly may be determined based on the sensor data obtained during a reference time prior to the occurrence of the data 412 outside the normal range. The data 412 outside the normal range may correspond to data outside a normal range 411 set for the first piece of equipment. The normal range 411 of the first piece of equipment may be represented by an upper specification limit and a lower specification limit of sensor data, and the normal range 411 may be determined based on at least one of a type of the first piece of equipment, a process in which the first piece of equipment is used, a normal range of sensor data of the first piece of equipment, and a sensor of the first piece of equipment. In addition, as the normal range 411 may vary depending on an operating time of the first piece of equipment, the normal range 411 may vary depending on a time period within a reference time in which the sensor data is obtained.

In addition, a trend image for the sensor data of the first piece of equipment may include a one-time equipment management event 410, where the equipment management event 410 occurs during a period during which the sensor data of the first piece of equipment is collected, that is, a reference time prior to the occurrence of the data 412 outside a normal range. As described above, a change (for example, a change in dispersion) may occur in the sensor data of the first piece of equipment due to the equipment management event 410. Accordingly, the electronic apparatus may reflect context data, a detailed breakdown for the equipment management event 410, to the first trend image for the sensor data of the first piece of equipment.

Meanwhile, the second piece of equipment may be a piece of equipment that corresponds to the first piece of equipment (in other words, the same kind of the first piece of equipment), albeit one that is operating normally. In addition, as described above, one or more second pieces of equipment may be selected based on a predetermined standard from among multiple second pieces of equipment, and the one or more second pieces of equipment may be used to determine validity of an anomaly detected in the first piece of equipment, but as illustrated in FIG. 4, a single trend image of sensor data for one second piece of equipment is illustrated for a clearer, example description.

To determine the validity of an anomaly of the first piece of equipment, a trend image may be generated for sensor data of the second piece of equipment during a period corresponding to a reference time prior to the occurrence of the anomaly of the first piece of equipment (in other words, the same period from the same point). In other words, the trend image of the first piece of equipment and the trend image of the second piece of equipment may be a trend image generated during a same time period.

The second equipment may have a normal range 422 of operation, and the normal range 422 for the sensor data of the second piece of equipment and the normal range 411 for the sensor data of the first piece of equipment may be different. Accordingly, an upper specification limit and a lower specification limit of the normal range 422 for the sensor data of the second piece of equipment may be different from the upper specification limit and the lower specification limit of the normal range 411 for the sensor data of the first piece of equipment.

In addition, as illustrated in FIG. 4, unlike the first piece of equipment in which the equipment management event 410 occurs one time during the same reference time, in the example of the second piece of equipment, two equipment management events 420 and 421 may be depicted as occurring. As described above, a characteristic of an equipment management event (for example, an equipment part replacement history or a software update history) may be identical or different, and the sensor data of the second piece of equipment may be changed (for example, a change in dispersion) by the equipment management events 420 and 421. Accordingly, the electronic apparatus may reflect context data, a detailed breakdown for the equipment management events 420 and 421, to the second trend image for the sensor data of the second piece of equipment.

Here, the first trend image and the second trend image may constitute a trend pair. When the one or more second pieces of equipment, which are selected from among various second pieces of equipment, are used to determine validity the anomaly detected in the first piece of equipment, the second trend image may be generated as described above for each of the sensor data of the second piece of equipment. In other words, one or more second trend images may be generated. Each of the one or more second trend images correspond to the first trend image and constitute an individual trend pair. For example, when there are three second trend images, the first trend image and a first second trend image may constitute a first trend pair, the first trend image and a second trend image may constitute a second trend pair, and the first trend image and a third second trend image may constitute a third trend pair.

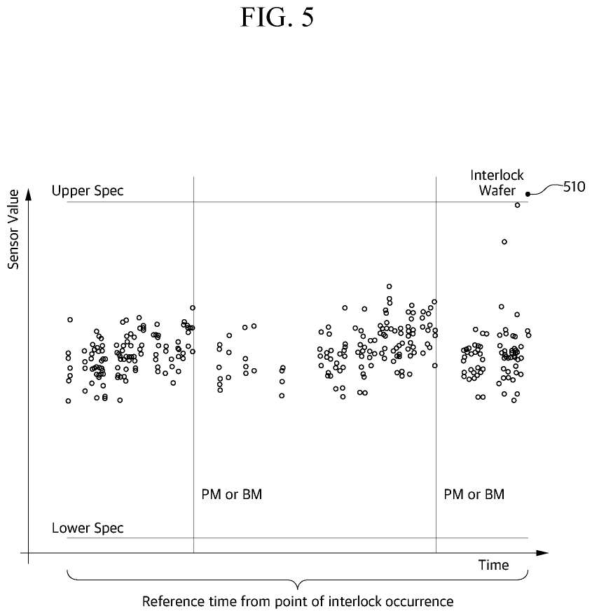

An example of the first trend image of the first piece of equipment will be described in greater detail below with reference to FIG. 5.

FIG. 5 illustrates example sensor data of first piece of equipment in which an anomaly is detected according to one or more embodiments. For example, when the first piece of equipment is one type of device within, for example, equipment used in a semiconductor wafer manufacturing process, the first trend image such as FIG. 5 may be generated from the sensor data of the first piece of equipment.

Referring to FIG. 5, in a non-limiting example, a first trend image of the first piece of equipment may be generated based on sensor data obtained during a reference time in the past (for example, during the recent one month from the point when sensor data 510 occurs) with respect to the sensor data 510 outside an upper specification limit or a lower specification limit of a normal range of the sensor data of the first piece of equipment. An upper specification limit and a lower specification limit may be set as a normal range of sensor data for each piece of equipment, and the normal range may be determined depending on a type of a piece of equipment, a type of a sensor, and a type of a process, and a reference time during which sensor data is obtained may be also determined depending on a type of a piece of equipment, a type of a sensor, and a type of a process. Meanwhile, the reference time may be set as a period of a sufficient length of time that may reflect a trend within the sensor data. For example, during a normal operation of a piece of equipment, if it is characterized that a trend of sensor data slopes downward to the right for n days from a starting point, increases again, and then slopes downward to the right again for the next n days repeats, or that a trend slopes downward to the right for n days after an equipment management event occurs, a reference time during which sensor data is obtained may be, for example, n days or more, or time points that are multiples of n.

Meanwhile, in the illustrated example of FIG. 5, two equipment management events occurred during the illustrated reference time. The equipment management events may include, for example, a preventive maintenance (PM) event and a breakdown maintenance (BM) event. In addition, the first trend image may include context data, a detailed breakdown for the equipment management event, including a type of an equipment management event.

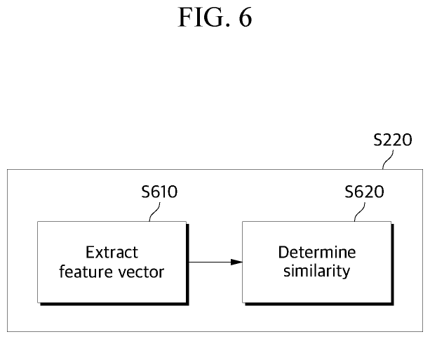

FIG. 6 illustrates an example process with determining a similarity based on an artificial intelligence model according to one or more embodiments. Referring to FIG. 6, in a non-limiting example, an AI model-based processing procedure is illustrated where the illustrated processing procedure which may be included in a method of equipment management so that an electronic apparatus such as the electronic apparatus 110 of FIG. 1 may perform the procedure. In addition, in an example, steps S610 and steps S620, may be included in an example of the AI model-based processing step S220 of FIG. 2.

In an example, an electronic apparatus (e.g., electronic device 1300 of FIG. 13) may determine an AI-based similarity for one or more trend pairs based on a trend image (for example, a first trend image and one or more second trend images) for sensor data of each piece of equipment (for example, a first piece of equipment and one or more second pieces of equipment).

Specifically, in an example, in step S610, an encoder included in the electronic apparatus may extract a feature vector from each trend image included in a trend pair using an AI model. The encoder may condense information included in a trend image by analyzing the trend image. In addition, step S610 may include a process extracting a feature vector from a trend image and a process of condensing the trend image into a low-dimensional feature vector. The encoder used in S610 may include various types of encoders including a neural network (NN), a convolutional NN (CNN), a transformer, a visual transformer, a long short-term memory, or MambaVision for extracting a feature vector from a trend image. However, the examples are not limited thereto.

In an example, in step S620, an electronic apparatus (e.g., electronic device 1300 of FIG. 13) may determine similarity using a feature vector extracted from each trend image. At this point, an AI model may be a model trained by a trend pair consisting of a pair of trend images.

In an example, the electronic apparatus may determine similarity based on a first feature vector extracted from the first trend image of the first piece of equipment (i.e., equipment with an anomaly) and a second feature vector extracted from the second trend image of the second piece of equipment (i.e., a normal operation). At this point, the similarity may be determined for each trend pair. In other words, the similarity may be determined based on the number of second trend pairs that depends on the number of second trend images.

Step S620 may be, for example, performed by a similarity analysis processing element that analyzes similarity between feature vectors. That is, the similarity analysis may be performed by a classifier or various distance measures (for example, a cosine similarity and a Euclidean distance) using the NN. For example, when the encoder extracts a feature vector, the classifier may determine similarity between each feature vector. Alternatively, the similarity analysis module may determine similarity between a first feature vector and a second feature vector based on various methods of determining similarity including the cosine similarity and the Euclidean distance between each feature vector.

At this point, a performance of the classifier may be associated with performance of the encoder for extracting the feature vector. For example, when the encoder performs a feature vector extraction function, the classifier may determine similarity between each feature vector by calculating a distance between each feature vector. In this case, the classifier may determine a similarity between the first feature vector and the second feature vector based on various methods of calculating similarity including the cosine similarity and the Euclidean distance. As another example, when the encoder learns feature vector extraction and a distance between each feature vector, the classifier may not separately perform calculation for the distance between feature vectors, but may determine similarity between trend images based on a distance between feature vectors that are already output.

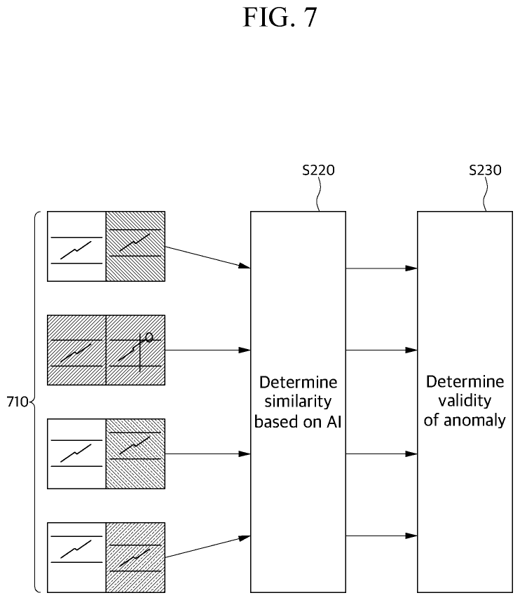

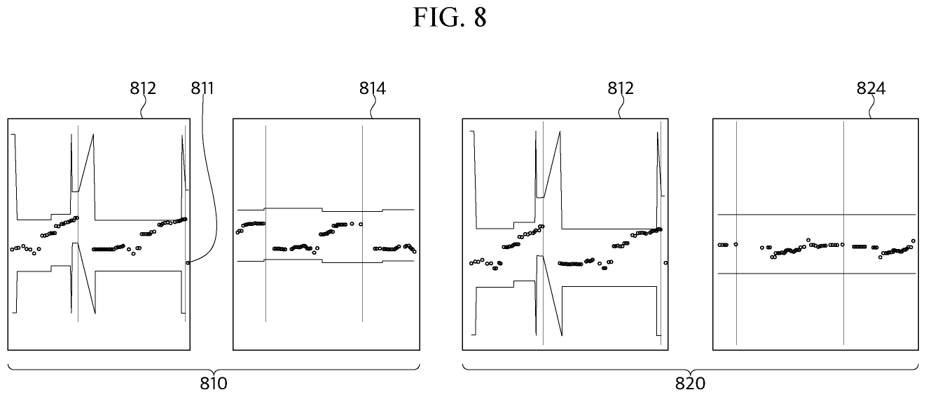

Based on the similarity determined by the aforementioned process, an example determination of a validity of an anomaly of the first piece of equipment will be described in greater detail below with reference to FIGS. 7 and 8.

FIG. 7 illustrates an example process with determining a validity of an anomaly detected in equipment, in consideration of similarity for each trend pair according to one or more embodiments. That is, FIG. 7 may illustrate a procedure of an AI model-based processing (e.g., step S220 of FIG. 2) and a procedure of determining validity of an anomaly (e.g., step S230 of FIG. 2) that may be included in a method of equipment management that an electronic apparatus such as the electronic apparatus 110 of FIG. 1 may perform.

Referring to FIG. 7, in a non-limiting example, four trend pairs 710 are illustrated. As described above, an electronic apparatus (e.g., electronic device 1300 of FIG. 13) may determine a similarity for each trend pair based on an AI model (e.g., in step S220). For example, the electronic apparatus may determine a similarity between trend images included in a first trend pair to be 70%, determine a second similarity between trend images included in a second trend pair to be 45%, determine a third similarity between trend images included in a third trend pair to be 89%, and determine a fourth similarity between trend images included in a fourth trend pair to be 87%.

In an example, an electronic apparatus (e.g., electronic device 1300 of FIG. 13) may determine a validity of an anomaly in step S230) for a first piece of equipment based on a similarity determined for each trend pair. The electronic apparatus, in step S230, may determine a validity of an anomaly of the first piece of equipment for each trend pair depending on the similarity of each trend pair. A reference value may be compared to the similarity. The reference value may be a value determined based on at least one of a process in which the first piece of equipment is used, similarity between the first piece of equipment and the second piece of equipment (for example, similarity between parts and similarity between software programs), a type of the first piece of equipment, and a type of a sensor included in the first piece of equipment.

For example, if a reference value is assumed to be 65%, when considering the first similarity of the first trend pair being 70%, it may be determined that an anomaly detected in the first piece of equipment in the first trend pair is a false positive. In addition, the electronic apparatus, considering the second similarity of the second trend pair being 45%, may determine that an anomaly of the first piece of equipment in the second trend pair is a true positive. That is, in other words, the second trend pair shows a normal detection. In addition, the electronic apparatus, when considering the third similarity of the third trend pair being 89%, it may be determined that an anomaly of the first piece of equipment in the third trend pair is a false positive. That is, in other words, a false detection. In addition, the electronic apparatus, when considering the fourth similarity of the fourth trend pair being 87%, it may be determined that an anomaly of the first piece of equipment in the fourth trend pair is also a false positive. That is, in an example, for each anomaly being detected for the first piece of equipment, the respective validity for those anomalies may be independently determined for each trend pair, and the validity of the anomaly detected in the first piece of equipment may be finally determined by gathering validity of an anomaly determined independently.

For example, as illustrated in FIG. 7, based on three occurrences of a false positive anomaly determination and one occurrence of a true positive anomaly determination, the electronic apparatus may finally determine a validity of the anomaly of the first piece of equipment. Here, the electronic apparatus, based on a threshold count for a number of false positive detections, may finally determine validity of the anomaly of the first piece of equipment. In other words, by comparing a count that the anomaly of the first piece of equipment is identified as a false positive and the threshold count based on similarity, a validity of the anomaly detected in the first piece of equipment may be determined. The threshold count, for example, may be a value determined based on at least one of a process in which the first piece of equipment is used, an accident history of the first piece of equipment, and the number of the second pieces of equipment. In the aforementioned example embodiment, when the threshold count is 2, based on three occurrences of false positive determination and one occurrence of a true positive determination, the electronic apparatus may determine that the anomaly of the first piece of equipment is identified as a false positive (i.e., a false detection). In this case, the electronic apparatus may transmit an interlock release request to the first piece of equipment to release an interlock of the first piece of equipment.

FIG. 8 illustrates an example trend pair including a first trend image and a second trend image according to one or more embodiments.

Referring to FIG. 8, in a non-limiting example, in a first trend pair 810 and a second trend pair 820, a trend image positioned to the left of each trend pair may be a first trend image 812 of a first piece of equipment, and a trend image positioned to the right may be a second trend image 814 and 824 of a second piece of equipment.

As an example, in the first trend pair 810, the first trend image 812, as described above, may be an image generated based on sensor data obtained during a reference time prior to a point at which data 811 outside the normal range is generated. The second trend image 814 may be an image generated based on sensor data obtained from the second piece of equipment during a reference time identical to that of the first trend image. At this point, the electronic apparatus may determine an anomaly detected in the first piece of equipment as a false positive, in other words, a false detection, by comparing the first trend image 812 and the second trend image 814 of the first trend pair 810.

Meanwhile, the second trend pair 820 may include the first trend image 812 of the first trend pair 810 and a new second trend image 824. The electronic apparatus may determine that the new second trend image 824 is not similar to the first trend image 812, and accordingly, may determine the anomaly detected in the first piece of equipment as a true positive, in other words, a normal detection.

In other words, the electronic apparatus may determine validity of the anomaly detected in the first piece of equipment, in consideration of similarity between the first trend image 812 of the first piece of equipment in which an anomaly is detected and the second trend images 814 and 824 of one or more second pieces of equipment corresponding to the first piece of equipment and operating normally.

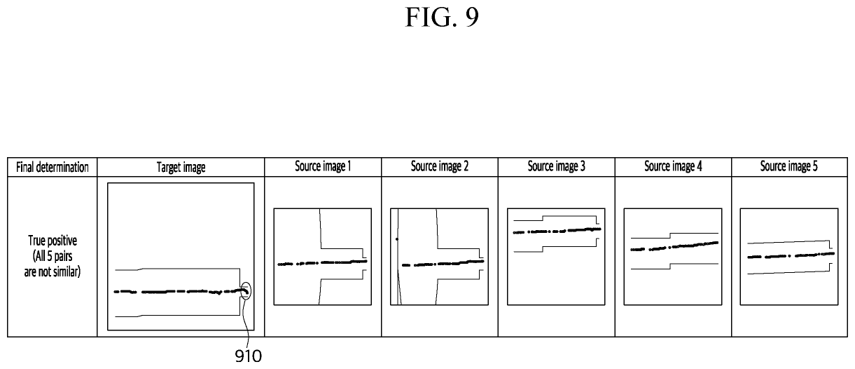

FIG. 9 illustrates an example process with determining a validity of an anomaly detected in a first piece of equipment according to one or more embodiments.

Referring to FIG. 9, in a non-limiting example, source images 1 to 5 may correspond to a trend image (a second trend image) of five second pieces of equipment selected from among multiple second pieces of equipment corresponding to the first piece of equipment and operating normally. In addition, a trend image (a first trend image) of the first piece of equipment may correspond to the target image. In other words, FIG. 9 may be an example of five trend pairs being generated based on the target image and the five source images.

All sensor data of the five source images may exhibit a trend that gently slopes ascending to right. However, as the target image exhibits rather a flat trend compared to the source images and a pattern in which sensor data rapidly decreases is also identified, it may be determined that the target image is not similar to all of the source images. Accordingly, the anomaly of the first piece of equipment may be determined as a true positive, in other words, a normal detection.

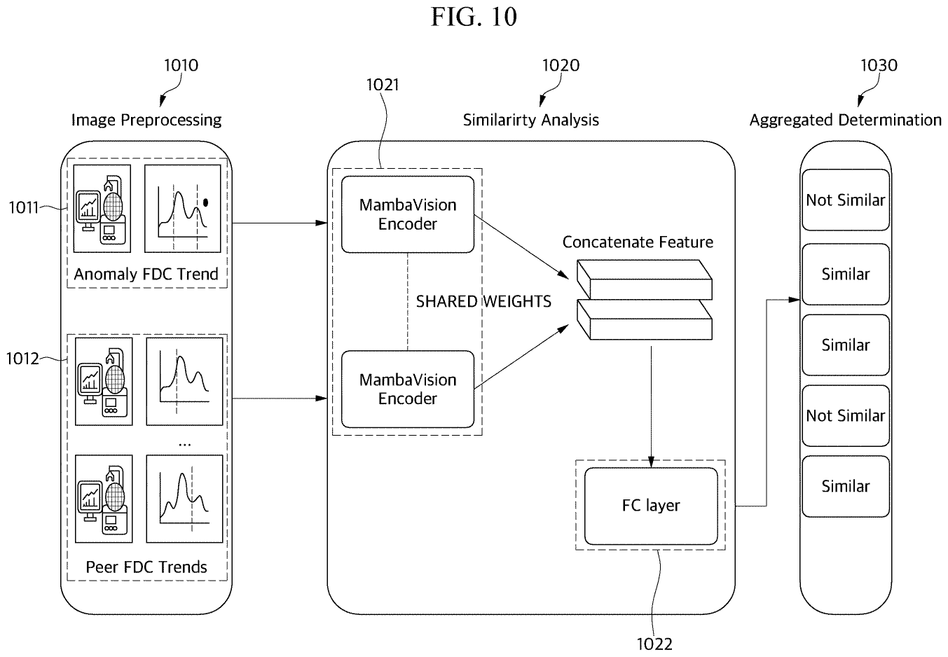

FIG. 10 illustrates an example process with determining a validity of an anomaly according to one or more embodiments. An example of FIG. 10 may be implemented by an electronic apparatus (in other words, a computing apparatus) including the electronic apparatus 110 of FIG. 1.

Referring to FIG. 10, in a non-limiting example, an electronic apparatus (e.g., electronic device 1300 of FIG. 13), as described above, may generate a first trend image for sensor data of a first piece of equipment 1011 and a second trend image for sensor data of a second piece of equipment 1012 and reflect an equipment management event for each piece of equipment to the trend image of each equipment. Such a trend image may be a fault detection and classification (FDC) trend image to detect and classify an anomaly. The electronic apparatus may generate a pair consisting of the trend image of the first piece of equipment and the trend image of the second piece of equipment, in other words, a trend pair in 1010.

The electronic apparatus may perform similarity analysis 1020 for each trend pair. Specifically, based on an encoder, a compressed feature vector for each trend image may be extracted, and similarity between trend images for each trend pair may be determined based on the extracted feature vector.

At this point, an encoder (for example, a MambaVision encoder) 1021 extracting a feature vector of each trend image and a classifier 1022 determining similarity based on the extracted feature vector may determine similarity between trend images for each trend pair.

For example, when the encoder 1021 includes one or more Mambavision encoders, the encoder 1021 may process each image independently to compare trend images included in a trend pair and extract a high-dimensional feature vector that encodes a structural and situational relationship. The Mambavision encoder may integrate a convolution layer with a state space model (SSM) for each trend image and efficiently extract a feature vector. Here, a MambaVision encoder corresponding to the first trend image and a MambaVision encoder corresponding to the second trend image may be separate but may share a weight (for example, a weight of a convolution layer) that is used when extracting a feature vector.

At this point, a feature vector corresponding to each trend image extracted by the encoder 1021 may be connected by a concatenate operation, and a first feature vector corresponding to the first trend image and a second feature vector corresponding to the second trend image may be determined. The first feature vector and the second feature vector may be input into a full connected (FC) layer of the classifier 1022, and similarity between trend images may be determined. Particularly, the classifier 1022 may be configured as a lightweight FC layer, and the lightweight FC layer may be a decision layer that may compute similarity while maintaining computational efficiency.

The electronic apparatus may aggregate whether each trend pair is similar, compare to a threshold count, and perform aggregated determination 1030 for validity of an anomaly detected in the first piece of equipment.

In the example illustrated in FIG. 10, the MambaVision encoder of encoder 1021 and the FC layer included in the classifier 1022 are illustrated as being used to determine validity of an anomaly of a piece of equipment, but the present disclosure is not limited thereto, and as described above, other encoders and classifiers based on various AI models may be applied to the present disclosure.

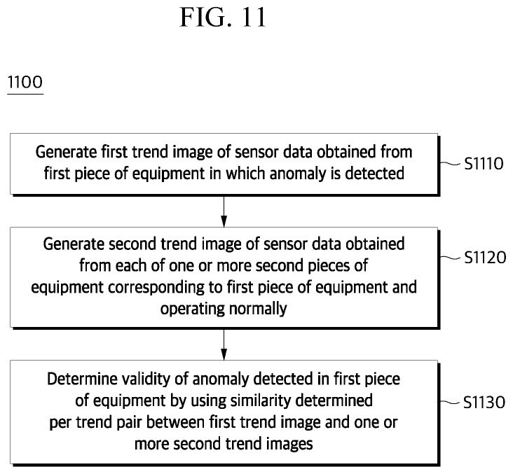

FIG. 11 illustrates an example method with equipment management according to one or more embodiments.

For example, FIG. 11 may be a method of equipment management based on example embodiments described with reference to FIGS. 1 to 10.

Referring to FIG. 11, in a non-limiting example, method 1100 may include, in step S1110, generating, by an electronic operation (e.g., electronic device 1300 of FIG. 13), a first trend image of sensor data obtained from a first piece of equipment in which an anomaly is detected. Here, the first trend image may correspond to an image generated based on an equipment management event occurred during a reference time of the first piece of equipment and the sensor data obtained from the first piece of equipment. The equipment management event of the first piece of equipment may include at least one of a maintenance history, a repair history, and a part replacement history of the first piece of equipment. The reference time may be variably set depending on each process or each sensor. In other words, as described above, the reference time may be determined based on a process including the first piece of equipment and a type of a piece of equipment included in the first piece of equipment. In addition, the first trend image may include a change (for example, a change in dispersion) of sensor data based on the equipment management event of the first piece of equipment. In addition, as described above, a normal range (an upper specification limit and a lower specification limit) of the sensor data may change based on the equipment management event of the first piece of equipment.

In an example, step S1120, may include generating, by an electronic apparatus (e.g., electronic device 1300 of FIG. 13) a second trend image of sensor data obtained from each one or more of the second pieces of equipment corresponding to the first piece of equipment and operating normally. Here, the second trend image may correspond to an image generated based on an equipment management event occurred during a reference time of the second piece of equipment and sensor data obtained from the second piece of equipment. The equipment management event of the second piece of equipment may include at least one of a maintenance history, a repair history, and a part replacement history of the second piece of equipment. Here, the reference time collecting the sensor data of the second piece of equipment may correspond to the reference time collecting the sensor data of the first piece of equipment. In addition, the second trend image may include a change (for example, a change in dispersion) of sensor data based on the equipment management event of the second piece of equipment. In addition, as described above, a normal range (an upper specification limit and a lower specification limit) of the sensor data may change based on the equipment management event of the second piece of equipment.

Meanwhile, one or more of the second pieces of equipment may be pieces of equipment selected based on one or more of a similarity to the first piece of equipment, an accident history for each second piece of equipment, and a ratio of anomaly validity determination per the second piece of equipment. In other words, the second trend image may be generated based on sensor data of each of the selected second pieces of equipment. The number of the second pieces of equipment and the number of the second trend images may be identical. In addition, the number of trend pairs, each of which generated to correspond to the first trend image and the second trend image, may be identical to the number of the second pieces of equipment and the number of the second trend images.

In an example, step S1130 may include determining a validity of the anomaly detected in the first piece of equipment, based on similarities determined for each trend pair between the first trend image and one or more second trend images, by an electronic apparatus (e.g., electronic device 1300 of FIG. 13). Meanwhile, respective similarities for each trend pair may be determined by an AI model including an encoder and a classifier that is selected in consideration of performance of the encoder.

At this point, an encoder corresponding to the first trend image and an encoder corresponding to the second trend image may operate separately, but these encoders may be of the same type, and may share a weight to extract a feature vector. In other words, the encoder may determine a first feature vector corresponding to the first trend image and a second feature vector corresponding to the second trend image, and the classifier may determine similarity between the first feature vector and the second feature vector.

Meanwhile, as described above, the electronic apparatus may determine a validity of the anomaly detected in the first piece of equipment for each trend pair by comparing similarity between trend images to a reference value. The reference value may be a value determined based on at least one of a process in which the first piece of equipment is used, similarity between the first piece of equipment and the second piece of equipment (for example, similarity between parts and similarity between software), a type of the first piece of equipment, and a type of a sensor included in the first piece of equipment.

When finally determining a validity of the anomaly detected in the first piece of equipment, the electronic apparatus may aggregate validities of the anomaly in the first piece of equipment determined for each trend pair and compare a number of times the anomaly in the first piece of equipment is identified as a false detection to a threshold value so as to finally determine the validity of the anomaly detected in the first piece of equipment. When the anomaly of the first piece of equipment is finally identified as a false detection (i.e., after comparing a number of the anomaly detections to the threshold value), the electronic apparatus may request to release an interlock state of the first piece of equipment, or the electronic apparatus may directly release the interlock state of the first piece of equipment. Meanwhile, as described above, the threshold value may be a value (or count) determined based on at least one of a process in which the first piece of equipment is used, an accident history of the first piece of equipment, and the number of the second pieces of equipment.

In addition method 1100 may be implemented by an electronic device (e.g., electronic device 1300 of FIG. 13) using at least one processor (for example, a central processing unit (CPU) or a graphics processing unit (GPU)) of an electronic apparatus, and may be performed only in one processor (for example, a CPU or a GPU) or performed based on information exchange between different processors (for example, a CPU and a GPU).

In addition, examples of method 11100 may be recorded as a program on a computer-readable medium. In addition, as FIG. 11 is an example embodiment of the present disclosure, some operations may be added or omitted, and a sequence of some operations may be changed in an example embodiment of the present disclosure.

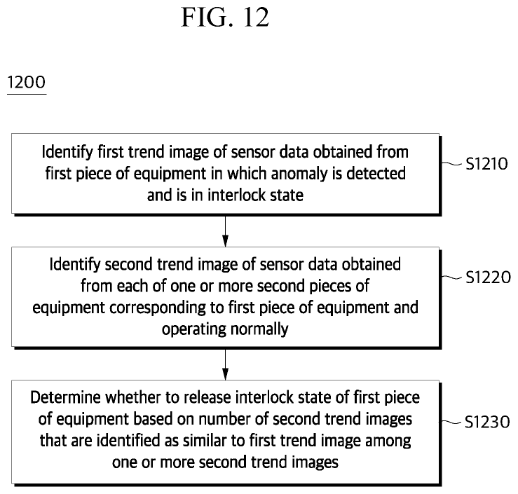

FIG. 12 illustrates an example method with equipment management according to one or more embodiments.

In addition, FIG. 12 may be a method with equipment management based on the above examples described with reference to FIGS. 1 to 11.

Referring to FIG. 12, in a non-limiting example, method 1200 may include, in step S1210, identifying a first trend, by an electronic apparatus (e.g., electronic device 1300 of FIG. 13), based on sensor data obtained from a first piece of equipment in which an anomaly is detected and is in an interlock state. Here, the first trend image may correspond to an image generated based on an equipment management event occurred during a reference time of the first piece of equipment and sensor data obtained from the first piece of equipment. The equipment management event of the first piece of equipment may include one or more of a maintenance history, a repair history, and a part replacement history of the first piece of equipment. The reference time may be variably set depending on each process or each sensor. In other words, as described above, the reference time may be determined based on a process including the first piece of equipment and a type of a piece of equipment included in the first piece of equipment. In addition, the first trend image may include a change (for example, a change in dispersion) of sensor data based on the equipment management event of the first piece of equipment. In addition, as described above, a normal range (an upper specification limit and a lower specification limit) of the sensor data may change based on the equipment management event of the first piece of equipment.

In an example, step S1220, may include identifying, by an electronic apparatus (e.g., electronic device 1300 of FIG. 13), a second trend image of sensor data obtained from each one or more second pieces of equipment (i.e., second equipment) corresponding to the first piece of equipment, where the second equipment is operating normally. Here, the second trend image may correspond to an image generated based on an equipment management event occurred during a reference time of a second piece of equipment and sensor data obtained from the second piece of equipment. The equipment management event of the second piece of equipment may include one or more of a maintenance history, a repair history, and a part replacement history of the second piece of equipment. Here, the reference time for collecting the sensor data of the second piece of equipment may correspond to the reference time collecting the sensor data of the first piece of equipment. In addition, the second trend image may include a change (for example, a change in dispersion) of sensor data based on the equipment management event of the second piece of equipment. In addition, as described above, a normal range (an upper specification limit and a lower specification limit) of the sensor data may change based on the equipment management event of the second piece of equipment.

Meanwhile, the one or more second pieces of equipment may be second equipment that was selected in consideration of one or more of a similarity to the first piece of equipment, an accident history of each second piece of equipment, a rate of anomaly validity determination for each second piece of equipment. In other words, the second trend image may be generated based on sensor data of each of the selected second pieces of equipment. The number of the second pieces of equipment and the number of the second trend images may be identical. In addition, the number of trend pairs, each of which generated to correspond to the first trend image and the second trend image, may be identical to the number of the second pieces of equipment and the number of the second trend images.

In an example, step S1230 may include determining, by an electronic apparatus (e.g., electronic device 1300 of FIG. 13), whether to release an interlock state of the first piece of equipment based on the number of the second trend images that are identified similar to the first trend image from among one or more second trend images. Here, the number of second trend images that are identified as being similar may be identical to the count in which an anomaly of the first piece of equipment is determined as a normal detection per trend pair. In other words, similarities between trend images may be determined per trend pair, and at this point, a validity of the anomaly detected in the first piece of equipment may be finally determined in consideration of a comparison result between the number of the second trend images that are similar to a trend image of the first piece of equipment and a threshold count.

Meanwhile, whether the second trend image is similar to the first trend image may be identified based on a similarity between the first trend image and the second trend image. That is, this similarity (i.e., between the first and second trend images) may be a similarity per trend pair. Here, a similarity may be compared to a threshold value that is a reference value determined based on at least one of a process in which the first piece of equipment is used, a similarity between the first piece of equipment and the second piece of equipment (for example, similarity between parts and similarity between software), a type of the first piece of equipment, and a type of sensor included in the first piece of equipment, and depending on a comparison result, it may be identified that the second trend image is similar to or not similar to the first trend image.

Meanwhile, a similarity for each trend pair may be determined based on an AI model including an encoder and a classifier that is selected in consideration of performance of the encoder. An encoder corresponding to the first trend image and an encoder corresponding to the second trend image may operate separately, but these encoders may be of the same type, and may share a weight to extract a feature vector. In other words, the encoder may determine a first feature vector corresponding to the first trend image and a second feature vector corresponding to the second trend image, and the classifier may determine similarity between the first feature vector and the second feature vector.

Meanwhile, the electronic apparatus may determine whether to release an interlock state of the first piece of equipment by considering a validity of the anomaly detected in the first piece of equipment. At this point, a final validity of the anomaly detected in the first piece of equipment may be determined by comparing the number of times in which an anomaly of the first piece of equipment is identified as a false detection with a threshold count by aggregating validity of an anomaly of the first piece of equipment determined per trend pair. When the anomaly of the first piece of equipment is finally identified as a false detection, the electronic apparatus may request to release the interlock state of the first piece of equipment, or the electronic apparatus may directly release the interlock state of the first piece of equipment. Meanwhile, as described above, the threshold count may be a value determined based on one or more of a process in which the first piece of equipment is used, an accident history of the first piece of equipment, and the number of the second pieces of equipment.

In addition, method 1200 may be implemented an electronic device (e.g., electronic device 1300 of FIG. 13) by using at least one processor (for example, a CPU or a GPU) of an electronic apparatus, and may be performed only in one processor (for example, a CPU or a GPU) or based on information exchange between different processors (for example, a CPU and a GPU).

In addition, examples of method 1200 may be recorded as a program on a computer-readable medium. In addition, as FIG. 12 is an example embodiment of the present disclosure, some operations may be added or omitted, and a sequence of some operations may be changed in an example embodiment of the present disclosure.

FIG. 13 illustrates an example electronic apparatus according to one or more embodiments.

Referring to FIG. 13, in a non-limiting example, an electronic apparatus 1300 may include one or more processors 1310 and a memory 1320. Description about the aforementioned example may be applied to the electronic apparatus 1300, and the one or more processors 1310 may perform an operation needed for example operations.

The one or more processors 1310 may control the entire operation of the electronic apparatus 1300. The one or more processors 1310 may be configured as at least one hardware unit. In addition, the one or more processors 1310 may be operated by one or more software modules that are generated by executing one or more commands stored in the memory 1320. The one or more processors 1310 may control example embodiments performed by the electronic apparatus 1300 through interaction with elements that may be further included in the memory 1320 and the electronic apparatus 1300.

The one or more processors 1310 may include a first processor 1311 and a second processor 1312. In an example, the first processor 1311 may control operations of the electronic apparatus 1300, and the second processor 1312 may process operations for an AI-based model as a processor having a structure advantageous for parallel processing. In other words, as the second processor 1312 may be configured to process operations for the AI-based model rather efficiently, so that the second processor 1312 may be used for a process to use a model or learn a model. In other words, the first processor 1311 and the second processor 1312 may be linked and independently perform some operations of the method of equipment management.

The one or more processors 1310 may be configured to execute programs or applications to configure the one or more processors 1310 to control the electronic apparatus 1300 to perform one or more or all operations and/or methods involving the detection of defect pattern similarities, and may include any one or a combination of two or more of, for example, a CPU, an application processor (AP), and a digital signal processor (DSP), graphics-specific processors such as a GPU and a vision processing unit (VPU), or neural network model-specific processors such as a neural processing unit (NPU), and various other processors.

For example, the first processor 1311 may be a CPU, and the second processor 1312 may be at least one among a GPU and an NPU, but is not limited thereto. Each operation of the method of equipment management performed by the electronic apparatus 1300 may be performed by any one of processors among the first processor 1311 and the second processor 1312 that are physically distinguished.

Alternatively, when the first processor 1311 and the second processor 1312 are identical processors unlike the example illustrated in FIG. 13, this case may nonetheless be included in the scope of right of the present specification, and in this case, an operation of the method with equipment management may be performed by one processor. In this case, a processor may be implemented as, for example, a system on chip (SoC) form.

The memory 1320 may include computer-readable instructions. The one or more processors 1310 may be configured to execute computer-readable instructions, such as those stored in the memory 1320, and through execution of the computer-readable instructions, the one or more processors 1310 may be configured to perform one or more, or any combination, of the operations and/or methods described herein.. The memory 1320 may record or store at least a portion of a management history including an AI-based model, learning data, verification data, sensor data for each piece of equipment, a trend image of sensor data, and a management event of each piece of equipment, and similarity of each piece of equipment.

It should be understood by those who skilled in the art that other universal components other than those illustrated in FIG. 13 may be further included. The aforementioned description may be applied to the electronic apparatus 1300, but overlapping descriptions will be omitted.

According to an example embodiment, the first processor 1311 may generate a first trend image of sensor data obtained from a first piece of equipment in which an anomaly is detected and generate a second trend image of sensor data obtained from each of one or more second pieces of equipment corresponding to the first piece of equipment and operating normally. The second processor 1312 may determine similarity of each trend pair between the first trend image and one or more second trend images. The first processor 1311 may determine validity of an anomaly detected in the first piece of equipment in consideration of similarity determined per trend pair.

In an example, the first processor 1311 may identify a first trend image of sensor data obtained from the first piece of equipment in which the anomaly is detected and in an interlock state and identify a second trend image of sensor data obtained from each of the one or more second pieces of equipment corresponding to the first piece of equipment and operating normally. The second processor 1312 may determine whether the one or more second trend images are similar to the first trend image. Based on the number of the second trend images determined to be similar, the first processor 1311 may determine whether to release the interlock state of the first piece of equipment. In this case, the first trend image, the second trend image, and the number of the second trend images identified similar may be directly obtained from the one or more processors 1310, but obtained from another device through a transceiver.

In addition, descriptions about example embodiments of FIGS. 1 to 12 may be applied to the electronic apparatus of FIG. 13, and the memory 1320 may perform an operation needed for an example operation. As descriptions applicable to the electronic apparatus are identical to the descriptions with reference to another diagram, overlapping descriptions will be omitted.

In an example, anomaly detection for equipment may be general-purpose, being not limited by a manufacturing process or a sensor, and robust anomaly detection for equipment may be provided even during an equipment management event. In addition, when detecting an anomaly of a piece of equipment, a risk of incorrectly determining a piece of equipment with an anomaly as a normal piece of equipment may be minimized by comparing with a trend image of multiple second pieces of equipment operating normally and preventing a false detection. In addition, management loss may be reduced when an anomaly occurs in a piece of equipment used for a manufacturing process by performing consistent comparison verification to the same type of multiple second pieces of equipment and verifying validity of an anomaly of a piece of equipment.

According to an example embodiment, the electronic apparatus 1300 may be applied to a system such as a notebook, a desktop, a laptop, a smartphone, a tablet, an MP3 player, a personal digital assistant (PDA), a portable multimedia player (PMP), a digital TV, a digital camera, a portable game console, a navigation device, a wearable device, a virtual reality (VR) device, an augmented reality (AR) device, and a drone.

The electronic apparatuses, processors, memories, neural networks, electronic apparatus 1300, first processor 1311, second processor 1312, memory 1320, electronic apparatus 110, equipment 130, encoder 1021, and FC layer 1022 described herein, including descriptions with respect to respect to FIGS. 1-13, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-13 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a first trend image of first sensor data responsive to detecting an anomaly in a first piece of equipment, the first sensor data observing the first piece of equipment;
generating one or more second trend images of second sensor data obtained from normally operating one or more second pieces of equipment, a second equipment type of the one or more second pieces of equipment corresponding to a first equipment type of the first piece of equipment; and
determining a validity of the anomaly detected in the first piece of equipment by using a per trend similarity determined per trend pair formed between the first trend image and the one or more second trend images.

2. The method of claim 1, wherein the first trend image corresponds to a first image, the first image being generated based on a first equipment management event occurring during a first reference time of the first piece of equipment and the first sensor data, and
wherein the one or more second trend images correspond to a second image, the second image being generated based on a second equipment management event occurring during a second reference time of a second piece of equipment and the second sensor data.

3. The method of claim 2, wherein the first equipment management event includes one or more of a maintenance history, a repair history, and a part replacement history of each piece of equipment.

4. The method of claim 2, wherein the first reference time is set variably for first processes of the first piece of equipment measured by the first sensor.

5. The method of claim 2, wherein the first trend image includes a first change of the first sensor data based on the first equipment management event of the first piece of equipment, and
wherein the one or more second trend images include a second change of the second sensor data based on the second equipment management event of the second piece of equipment.

6. The method of claim 1, wherein the per trend similarity is determined based on an encoder and an artificial intelligence (AI) model including a classifier selected in consideration of the encoder.

7. The method of claim 6, wherein a first encoder corresponding to the first trend image and a second encoder corresponding to the one or more second trend images share a weight.

8. The method of claim 6, wherein the encoder determines a first feature vector corresponding to the first trend image and a second feature vector corresponding to the one or more second trend images, and
wherein the classifier determines a vector similarity between the first feature vector and the second feature vector.

9. The method of claim 1, wherein the generating of one or more second trend images comprises:
generating the one or more second trend images from respective ones of the one or more second pieces of equipment selected in consideration of one or more of a first similarity to the first piece of equipment, an accident history for each second piece of equipment, and a rate of anomaly validity determination for each second piece of equipment.

10. The method of claim 1, wherein the determining of the validity comprises:
determining the validity of the anomaly by comparing, in consideration of the trend similarity determined per the trend pair, a number of times the anomaly of the first piece of equipment is identified as a false detection with a threshold count.

11. The method of claim 10, further comprising:
responsive to the anomaly of the first piece of equipment being identified as a false detection, requesting a release of an interlock state of the first piece of equipment.

12. The method of claim 10, wherein the threshold count is a value determined based on one or more of a first process in which the first piece of equipment is used, an accident history of the first piece of equipment, and a number of the one or more second pieces of equipment.

13. A processor-implemented method, the method comprising:
identifying a first trend image of first sensor data obtained from a first equipment responsive to an anomaly being detected in the first equipment and the first equipment being in an interlock state;
identifying a second trend image of second sensor data obtained from normally operating second equipment, the second equipment corresponding to the first equipment ; and
determining whether to release the interlock state of the first equipment based on a number of one or more second trend images identified to be similar to the first trend image from among the one or more second trend images.

14. The method of claim 13, wherein the first trend image corresponds to a first image generated based on a first equipment management event occurring during a first reference time of the first equipment and the first sensor data, and
wherein the one or more second trend images correspond to second images generated based on a second equipment management event occurring during a second reference time of the second equipment and the second sensor data.

15. The method of claim 14, wherein the first equipment management event and the second equipment management event each include one or more of a maintenance history, a repair history, and a part replacement history of the first equipment and the second equipment.

16. The method of claim 14, wherein the first reference time is set variably for first processes of the first equipment measured by the first sensor.

17. The method of claim 14, wherein the first trend image includes a first change of the first sensor data based on the first equipment management event of the first equipment, and
wherein the one or more second trend images include a second change of the second sensor data based on the second equipment management event of the second equipment.

18. The method of claim 13, wherein the one or more second trend images are identified to be similar to the first trend image based on an encoder and an artificial intelligence (AI) model including a classifier selected in consideration of the encoder.

19. The method of claim 18, wherein a first encoder corresponding to the first trend image and a second encoder corresponding to the one or more second trend images share a weight.

20. An electronic apparatus, comprising:
one or more processors comprising processing circuitry; and
a memory comprising one or more storage media storing instructions that, when executed individually or collectively by the one or more processors, cause the electronic apparatus to:
generate a first trend image of first sensor data obtained from first equipment in which an anomaly is detected, and one or more second trend images of second sensor data obtained from one or more normally operating second equipment, the first equipment corresponding to the second equipment;
determine a similarity per trend pair between the first trend image and the one or more second trend images; and
determine a validity of the anomaly detected in the first equipment in consideration of the similarity.
